(19) United States
(12) Patent Application Publication
(10) Pub. No.: US 2005/0174258 A1
(43) Pub. Date: Aug. 11, 2005

(54) Gate management system and method for vehicle passage gate

(76) Inventors: Kazuki Yamanouchi, Chiba-shi (JP); Akira Morita, Niiza-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/516,995

(22) PCT Filed: Jun. 23, 2003
(86) PCT No.: PCT/JP03/07921

(30) Foreign Application Priority Data
Jun. 24, 2002 (JP) 2002-183542

(51) Int. Cl. G08G 1/00

(52) U.S. Cl. 340/928; 235/375; 340/5.2

(57) ABSTRACT

A gate management method in a gate management system having a gate device (2) installed at a vehicle entrance to a predetermined area and a gate management server (10) managing the entrance and exit of a passing vehicle reads barcode information displayed on a terminal moving with the vehicle when the vehicle passes the gate device, and determines whether to authorize the vehicle to pass based on the read barcode information.

### TECHNICAL FIELD

The present invention relates to the gate management of a gate through which vehicles pass, particularly to a gate management system and method using an identification code such as a barcode.

### BACKGROUND ART

In general, in predetermined areas that vehicles enter or exit from, such as toll roads and port facilities, gates for admission thereto, such as tollgates or admission gates, are provided. Vehicle drivers pay tolls, identify themselves, and conduct other various procedures at such gates.

However, the above-described procedures are apt to be complicated, thus causing the problem of vehicle congestion at the gates. In these days, when passing vehicles are on the increase, vehicle congestion has become more serious, so that sometimes trucks are backed up in a line up to public roads particularly at gates at work sites such as port facilities.

The present invention, made in view of the above-described point, has an object of providing a gate management method, a gate management system, a gate device, a gate management server, and a gate management program that allow vehicles to pass through gates smoothly by shortening passage procedure time at the gates.

### DISCLOSURE OF THE INVENTION

In order to solve the above-described problem, a gate management method used in a gate management system, composed of a gate device installed at a vehicle entrance to a predetermined area and a gate management server managing the entrance and exit of a passing vehicle, is provided. This method includes the identification code reading step of reading identification code information displayed on a terminal moving with the vehicle when the vehicle passes the gate device and the passage authorization determination step of determining whether to authorize the vehicle to pass based on the read identification code information.

The terminal moving with the vehicle is, for instance, a mobile terminal mounted in the vehicle, such as a car navigation device or an automobile telephone, or a mobile terminal such as a cellular phone carried by the crew of the vehicle. By merely presenting a barcode or another identification code displayed on such a terminal to the gate device, it is determined immediately whether to authorize the vehicle to pass through a gate. As a result, procedure time at the gate is shortened, thus allowing smooth passage of vehicles through the gate.

This method further includes the destination determination step of determining the destination of the vehicle in the predetermined area based on the read identification code information at the time of the entrance of the vehicle and the destination notification step of notifying the terminal of the destination of the vehicle determined in the destination determination step.

According to this gate management method, the terminal moving with the vehicle is notified of the destination in the predetermined area at the time of passing the gate. Accordingly, a driver can learn of a location to which the vehicle should be directed immediately, thus allowing the vehicle to pass through the gate smoothly. Here, the predetermined area inside the gate is, for instance, where work arises inside the gate, such as a port facility, a parking lot, or a toll road.

The above-described gate management method further includes the gate passage notification step of notifying a first communications terminal related to the destination of the vehicle that the vehicle has passed the gate device based on the determination result in the passage authorization determination step.

According to this gate management method, it is possible to give advance notification to, for instance, a worker assigned to the destination of the vehicle of the passage of the vehicle through the gate. Accordingly, when the vehicle arrives, the worker can recognize the vehicle immediately. Further, the worker can start to prepare for related work when the vehicle passes through the gate, so that work efficiency increases.

Further, the above-described gate management method further includes the exit notification step of notifying a predetermined second communications terminal that the vehicle has exited based on the identification code information at the time of the exit of the vehicle.

According to this gate management method, for instance, a requestor who has made a request to load or pick up cargo can recognize from a remote place that the vehicle has exited from the gate and that work is completed.

The first and second communications terminals are, for instance, portable terminals. In this case, the destination or the exit of the vehicle is reported to the portable terminals. Accordingly, the exit of the vehicle can be recognized anytime and anywhere.

The predetermined area is, for instance, a port facility. In this case, it is possible to make the passage of vehicles smooth at the gate of the port facility.

Preferably, the gate management method further includes the charge amount determination step of determining the amount to be charged for use of the predetermined area based on the identification information read when the vehicle passes the gate.

According to this gate management method, the amount to be charged is determined when the vehicle enters or exits from the gate. Accordingly, reasonable charging corresponding to use of the predetermined area such as a port facility or a toll road can be performed.

As a second aspect of the present invention, a gate management system composed of a gate device installed at a vehicle entrance to a predetermined area and a gate management server managing the entrance and exit of a passing vehicle is provided. This gate management system includes identification code reading means for reading identification code information displayed on a terminal moving with the vehicle when the vehicle passes the gate device and passage authorization determination means for determining whether to authorize the vehicle to pass based on the identification code information read by the identification code reading means.

The gate management system further includes destination determination means for determining the destination of the vehicle in the predetermined area based on the read identification code information and destination notification means for notifying the terminal of the destination of the vehicle determined by the destination determination means.

The gate management system further includes gate passage notification means for notifying a first communications terminal related to the destination of the vehicle that the vehicle has passed the gate device based on the result of the determination of the passage authorization determination means.

The gate management system further includes exit notification means for notifying a predetermined second communications terminal that the vehicle has exited based on the identification code information at the time of the exit of the vehicle.

Preferably, it further includes charge amount determination means for determining the amount to be charged for use of the predetermined area based on the identification information read at the time of the passage of the vehicle.

As a third aspect of the present invention, a gate device installed at a vehicle entrance to a predetermined area and, together with a gate management server managing the entrance and exit of a passing vehicle, forming a gate management system is provided. The gate device includes identification code reading means for reading identification code information displayed on a terminal moving with the vehicle when the vehicle passes the gate device, identification code information transmission means for transmitting the identification code information read by the identification code reading means to the gate management server, and passage authorization output means for receiving passage authorization information from the gate management server and outputting the passage authorization information.

This gate device is suitably used in the above-described gate management system.

As a fourth aspect of the present invention, a gate management server connected to a gate device installed at a vehicle entrance to a predetermined area, and managing the entrance and exit of a vehicle passing the gate device is provided. The gate management server includes identification code information reception means for receiving from the gate device identification code information read from a terminal moving with the vehicle by the gate device when the vehicle passes the gate device, passage authorization determination means for determining whether to authorize the vehicle to pass based on the received identification code information, and passage authorization information transmission means for transmitting passage authorization information showing the result of the determination of the passage authorization determination means to the gate device.

This gate management server is suitably used in the above-described gate management system.

As a fifth aspect of the present invention, a gate management program to be installed in a gate management server connected via a network to a gate device installed at a vehicle entrance to a predetermined area, and managing the entrance and exit of a vehicle passing the gate device is provided, the gate management program causing the gate management server to perform a predetermined operation. This program causes the gate management server to execute the following processes: the identification code information reception process of receiving identification code information read from a terminal moving with the vehicle by the gate device when the vehicle passes the gate device; the passage authorization determination process of determining whether to authorize the vehicle to pass based on the received identification code information; and the passage authorization information transmission process of transmitting passage authorization information showing the passage authorization determination result to the gate device.

As a sixth aspect of the present invention, a storage medium on which the above-described gate management program is recorded is provided.

### BRIEF DESCRIPTION OF THE DRAWINGS

Other objects, features, and advantages of the present invention will become more apparent from the following detailed description when read in conjunction with the accompanying drawings, in which:

FIG. 1 is a diagram showing a configuration of a gate management system according to an embodiment of the present invention;

FIG. 2 is a diagram showing a hardware configuration of a gate management server;

FIG. 3 is a diagram showing a functional configuration of the gate management system;

FIG. 4 is a flowchart for illustrating a pick-up order operation;

FIG. 5 is a diagram showing a container information table forming a port DB;

FIG. 6 is a flowchart for illustrating a barcode displaying operation;

FIG. 7 is a diagram showing a password entry screen on a cellular phone;

FIG. 8 is a diagram showing a barcode display screen on the cellular phone;

FIG. 9 is a flowchart for illustrating a gate entrance operation;

FIG. 10 is a diagram showing a container location display screen on the cellular phone; and

FIG. 11 is a flowchart for illustrating a gate exit operation.

### BEST MODE FOR CARRYING OUT THE INVENTION

A description is given below, with reference to the drawings, of an embodiment of the present invention.

In this embodiment, a description is given of the case of applying the present invention to port facilities. Here, port facilities refer to places where cargos landed from ships and cargos loaded into ships are contained in containers and stored for a certain period of time when the cargos enter port as in the case of importing and when the cargos leave port as in the case of exporting, respectively. With respect to the arrival of cargo at and the shipment of cargo from a port facility, at the time of its arrival as in the case of importing, cargo is delivered from the port facility to a cargo owner, being contained in a container, by a truck of a carrier having received a request from the cargo owner. At the time of its shipment as in the case of exporting, cargo is contained in a container and delivered from a cargo owner to the port facility by a truck of a carrier also having received a request from the cargo owner. Further, the loading of cargo into a truck in the port facility is performed by stevedores of the port facility.

A description is given of a case where a barcode is employed as an identification code read by a gate device at the time of gate passage.

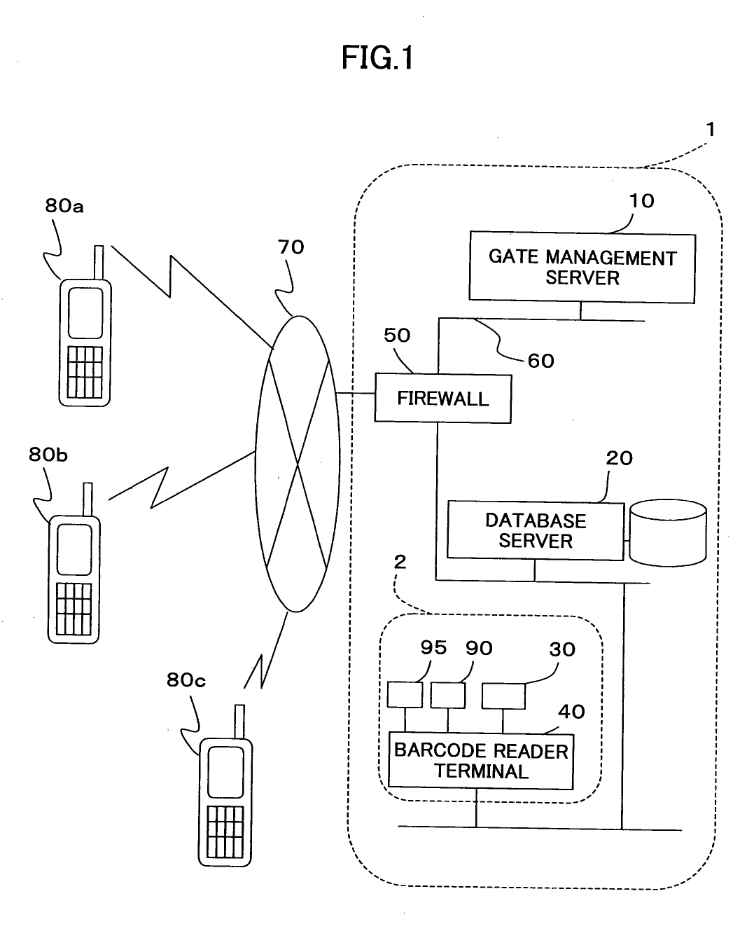

FIG. 1 is a diagram showing a configuration of a gate management system according to the embodiment of the present invention. A gate management system 1 of FIG. 1 includes a gate device 2, a gate management server 10 connected via a network 60 to the gate device 2, and a database server 20 connected via the network 60 to the gate management server 10. The gate device 2 includes a gate installed at the entrance of a port facility but not graphically represented, a barcode reader 30, a passage authorization lamp 90, a crossing gate 95, and a barcode reader terminal 40 such as a personal computer connected to the barcode reader 30, the passage authorization lamp 90, and the crossing gate 95. The gate management system 1 is connected to a network 70 such as the Internet via a firewall 50, and is accessible via the network 70 from a cargo owner cellular phone 80a possessed by a cargo owner, a trucker cellular phone 80b possessed by the driver or crew member of a truck of a carrier (hereinafter referred to as “trucker”), and a stevedore cellular phone 80c possessed by a stevedore in the port facility. The barcode reader 30 in the gate management system 1 reads a barcode displayed on the trucker cellular phone 80b when the truck passes through the gate of the port facility. The barcode reader terminal 40 transmits the information read by the barcode reader 30 to the gate management server 10. Further, the barcode reader terminal 40 receives the result of determination as to whether to authorize passage from the gate management server 10, and depending on the determination result, causes the passage lamp 90, for instance, to light up in blue when the passage is authorized and in red when not authorized.

The gate management server 10 determines whether to authorize the truck to pass through the gate based on the information received from the barcode reader terminal 40, and transmits the result of the determination to the barcode reader terminal 40. The gate management server 10 manages a variety of work information items and cargo-related and container-related information items in the port facility based on a variety of information items stored in the database server 20. Further, the gate management server 10 informs the cargo owner cellular phone 80a, the trucker cellular phone 80b, or the stevedore cellular phone 80c of the passage of the truck through the gate, the destination of the truck, etc.

The database server 20 does not always have to be physically independent of the gate management server 10. The gate management server 10 may also serve as the database server 20. Further, the cargo owner cellular phone 80a, the trucker cellular phone 80b, and the stevedore cellular phone 80c do not always have to be cellular phones, and may be portable information terminals such as PDAs (Personal Digital Assistants). Further, the cargo owner cellular phone 80a and the stevedore cellular phone 80c may also be other communications terminals such as personal computers. The trucker cellular phone 80b may also be a car navigation device or an automobile telephone mounted in the truck.

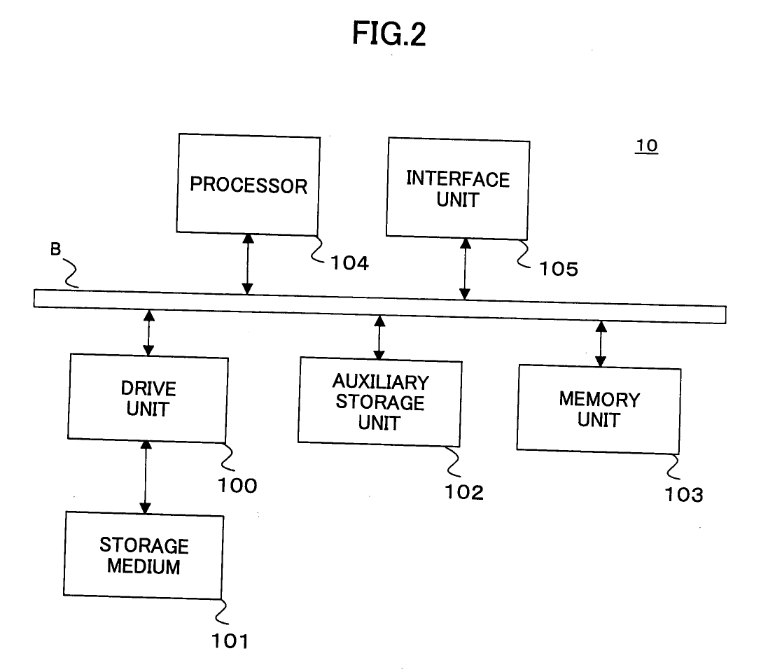

Next, a description is given of the details of the gate management server 10. FIG. 2 is a diagram showing a hardware configuration of the gate management server 10 according to the embodiment of the present invention. The gate management server 10 of FIG. 2 includes a drive unit 100, a storage medium 101, an auxiliary storage unit 102, a memory unit 103, a processor 104, and an interface unit 105, which are connected to one another via a bus B.

The interface unit 105 is composed of, for instance, a modem and a router, and is used to establish connection with the network 60 of FIG. 1.

A gate management program used by the gate management server 10 is provided by the storage medium 101 such as a CD-ROM. The storage medium 101 on which the gate management program is recorded is set in the drive unit 100, and the gate management program is installed in the auxiliary storage unit 102 through the drive unit 100 from the storage medium 101.

The auxiliary storage unit 102 stores the installed gate management program and necessary files and data.

The memory unit 103 reads out the gate management program from the auxiliary storage unit 102 and stores it when there is an instruction to start the gate management program at the time of, for instance, activation of the gate management server 10. The processor 104 executes functions relating to the gate management server 10 in accordance with the gate management program stored in the memory unit 103.

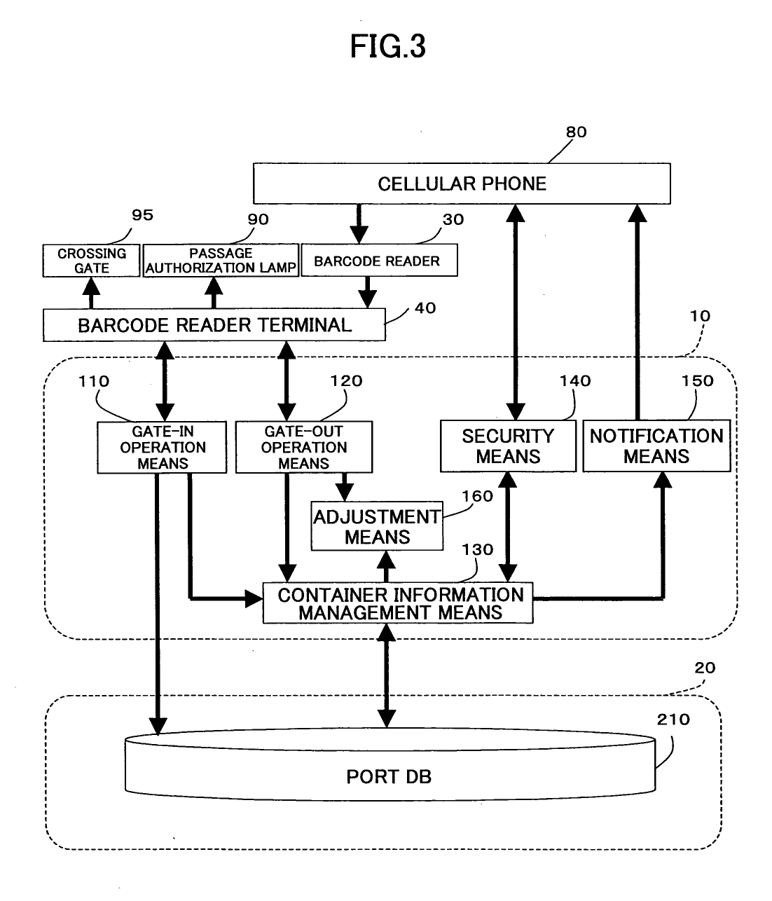

Further, a description is given of a functional configuration of the gate management system 1. FIG. 3 is a diagram showing a functional configuration of the gate management system 1. The gate management server 10 in the gate management system 1 has a gate-IN operation means 110, a gate-OUT operation means 120, a container information management means 130, a security means 140, a notification means 150, and an adjustment means 160. The database server 20 has a port DB (Database) 210 managing information on containers storing cargos. A cellular phone 80 is a generic representation for the cargo owner cellular phone 80a, the trucker cellular phone 80b, and the stevedore cellular phone 80c in FIG. 1.

The barcode reader terminal 40 transmits barcode information read from the cellular phone 80 by the barcode reader 30 to the gate-IN operation means 110 and the gate-OUT operation means 120. The gate-IN operation means 110 and the gate-OUT operation means 120 performs operations relating to entrance and exit, respectively, based on the barcode information transmitted from the barcode reader terminal 40. The container information management means 130 provides the container information in the port DB 210 to the cellular phone 80 accessing the gate management server 10 and other means, and performs a variety of operations relating to the container information. The security means 140 performs security operations such as a password check in response to external access to the gate management server 10, such as the cellular phone 80. The notification means 150 informs the cellular phone 80 of the passage of the truck through the gate and the destination of the truck. The adjustment means 160 calculates fees for the usage of the port facilities and containers.

A description is given below of the operating procedures of the gate management system 1 of FIG. 1, taking the case of receiving cargos as importing as an example.

First, a description is given of the operating procedure of the gate management system 1 in the case of a pick-up order. A pick-up order refers to an order for receiving a container storing cargo placed with the port facility, that is, the gate management system 1, by a carrier requested by a cargo owner to receive the cargo. When a trucker goes to the port facility to receive containers, a pick-up order should be placed in advance.

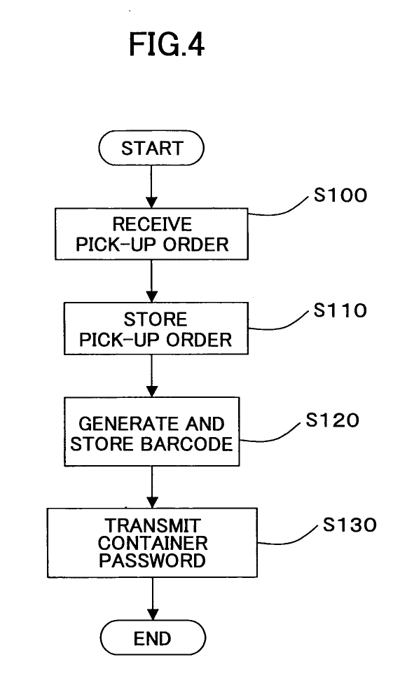

FIG. 4 is a flowchart for illustrating a pick-up order receiving operation. In step S100, the container information management means 130 of the gate management server 10 receives a pick-up order transmitted from the trucker cellular phone 80b. The contents of the pick-up order include, for instance, information for identifying a carrier and a trucker, the date of reception, and a container number as container identification information. The pick-up order may be made from a communications terminal such as a personal computer of the carrier through the network 70.

In step S110, the container information management means 130 stores the received pick-up order in the container information table of the port DB 210.

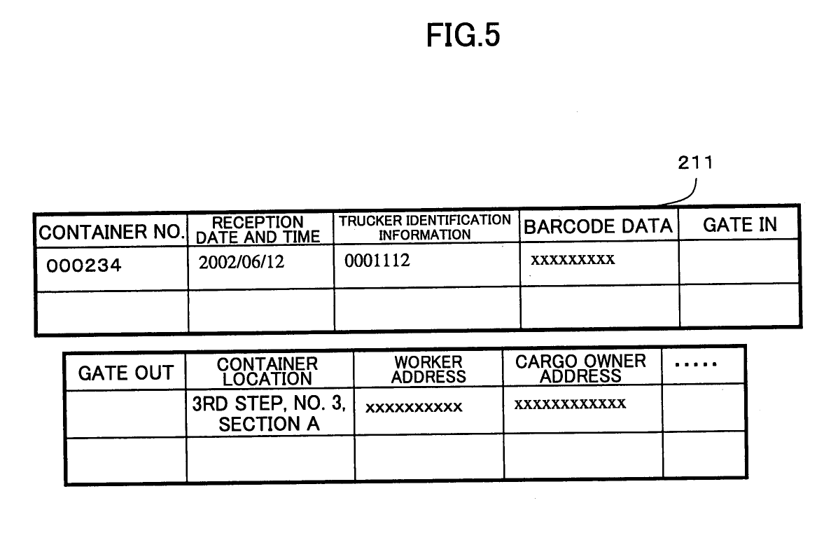

FIG. 5 shows a container information table forming the port DB 210. A container information table 211 has a container number, a container reception date and time, the identification information of a trucker to pick up the container, information (a file path, etc.) indicating the storage location of below-described barcode image data assigned to the pick-up order of the container (hereinafter referred to as “barcode data”), a gate-IN item indicating whether a truck has entered, a gate-OUT item indicating whether a truck has exited, a container location in the gate port facility, the worker address (an email address, a cellular phone number, etc.) of a worker engaged in container loading, and a cargo owner address (email, a cellular phone number, a facsimile number, etc.) as data items. Accordingly, when a pick-up order for a container is placed, corresponding information is recorded in the data items such as the reception date and time and the barcode data.

In step S120, the container information management means 130 generates barcode data assigned uniquely to the pick-up order. The container information management means 130 stores the generated barcode data in the port DB 210, and records its storage location in the barcode data item of the container information table 211. The container number may be embedded in a barcode represented by the barcode data. Proceeding further to step S130, the container information management means 130 transmits a container password to the trucker cellular phone 80b, and the operation ends. The barcode data generated herein is used when the trucker passes through the gate of the port facility as described below. Further, the container password is required when the trucker displays the barcode data on her/his cellular phone as described below.

Next, a description is given of the operating procedure of the gate management system 1 in the case of the trucker displaying the barcode on the trucker cellular phone 80b when or before arriving at the gate of the port facility.

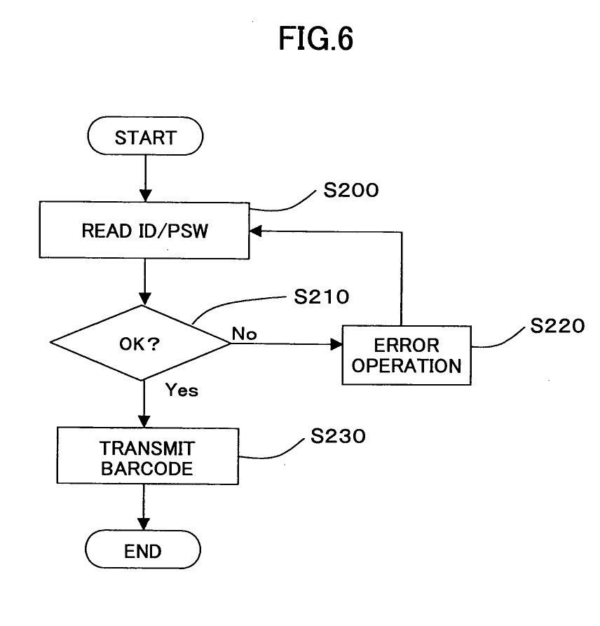

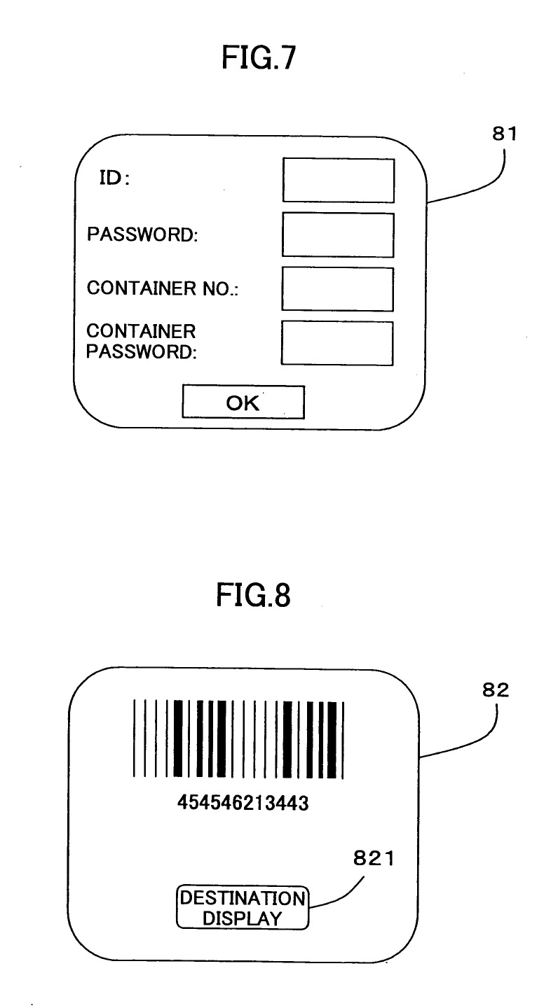

FIG. 6 is a flowchart for illustrating a barcode displaying operation performed in the gate management server 10. In step S200, the security means 140 of the gate management server 10 receives ID information and a password transmitted from the trucker cellular phone 80b. A password entry screen of the trucker cellular phone 80b is shown in FIG. 7. The trucker enters an ID and a password for identifying the trucker or the carrier, a container number for identifying a container, and a container password from a password entry screen 81 displayed on the trucker cellular phone 80b. The container password-is received in above-described step S130 of FIG. 4.

Proceeding to step S210 after step S200, the security means 140 makes an authentication check on the trucker based on the received ID information, etc. If the ID information, etc., includes an error, the security means 140 proceeds to step S220, and performs an error operation such as prompting the trucker cellular phone 80b to re-enter the ID information, etc. If the ID information, etc., is correct, step S230 is entered.

In step S230, the container information management means 130 transmits the barcode data stored in the port DB 210 to the trucker cellular phone 80b, and the operation ends.

FIG. 8 shows a barcode display screen on the cellular phone 80b. The barcode data transmitted from the gate management server 10 is displayed on a barcode display screen 82. The trucker may prestore the barcode display screen 82 in the trucker cellular phone 80b before arriving at the gate. The barcode may be a two-dimensional barcode or the like, and is not limited to a particular type.

Next, a description is given of the operating procedure of the gate management system in the case of the truck entering the port facility through the gate.

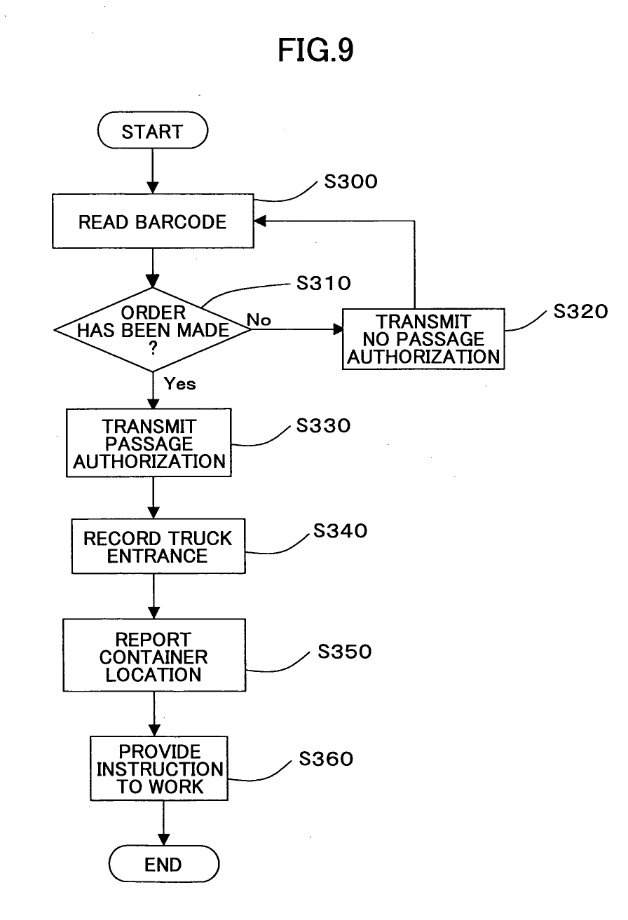

FIG. 9 is a flowchart for illustrating a gate entrance operation. In step S300, the barcode reader 30 reads the barcode, that is, the barcode display screen 82 of FIG. 8, presented by the trucker cellular phone 80b, and the barcode reader terminal 40 transmits the barcode information to the gate-IN operation means 110 of the gate management server 10. If the barcode display screen 82 is prestored in the trucker cellular phone 80b, the trucker has only to call the stored screen in displaying the barcode on the trucker cellular phone 80b.

In step S310, the gate-IN operation means 110 determines whether a pick-up order has been made by retrieving a record corresponding to the container number shown by the barcode information from the container information table 211 of FIG. 5. For instance, if the reception date and time of the corresponding record is recorded, it means that the pick-up order has been made, and if not, it means that the pick-up order has not been made.

If the pick-up order has not been made (NO in S310), step S320 is entered, where the gate-IN operation means 110 transmits a message that passage is not authorized to the barcode reader terminal 40. At this time, the barcode reader terminal 40 causes the passage authorization lamp 90 to light up in red. If the pick-up order has been made (YES in S310), step S330 is entered.

In step S330, the gate-IN operation means 110 transmits a message that passage is authorized to the barcode reader terminal 40. At this time, the barcode reader terminal 40 causes the passage authorization lamp 90 to light up in blue, and opens the crossing gate 95 so as to allow the truck to pass.

In step S340, the gate-IN operation means 110 records the entrance of the truck in the gate-IN data item of the container information table 211 of FIG. 5. Further, in step S350, the container information management means 130 retrieves the container location from the container information table 211, and notifies the trucker cellular phone 80b of the container location.

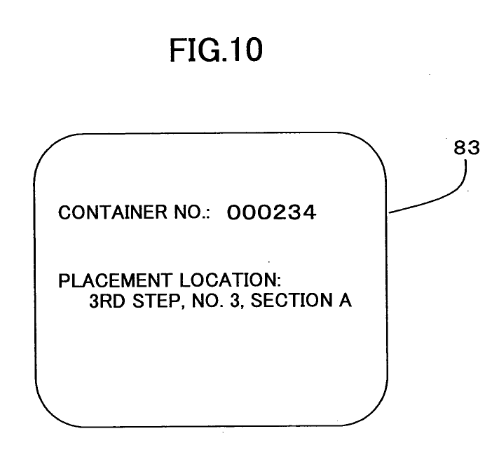

FIG. 10 shows a container location display screen on the cellular phone. The number, placement location, etc., of a container are displayed on a container location display screen 83. The container location display screen 83 may be displayed by pressing a destination display button 821 of FIG. 8 or be transmitted by email. Alternatively, it may also be telephoned by automatic voice telephone or be displayed on a monitor provided at the gate.

Proceeding to step S360 after step S350 of FIG. 9, the container information management means 130 obtains a worker address from the container information table 211. Further, the notification means 150 notifies the cellular phone 80c of a stevedore who loads the container of the passage of the truck through the gate and information such as the container location based on the obtained worker address, and the operation ends. This notification may be transmitted by email or telephoned by automatic voice telephone. With respect to the information such as the container location, only the container number may be reported instead of detailed information. In this case, the stevedore may access the gate management system 1 from the stevedore cellular phone 80c, and after being authenticated by the security means 140 of the gate management server 10, check the detailed information of the container through the container information management means 130.

As described above, the trucker can smoothly pass through the gate by only presenting the barcode displayed on the trucker cellular phone 80b to the barcode reader 30. Further, the trucker can learn of the container location simultaneously as the trucker passes through the gate, while the stevedore can learn of the container location, that is, the destination of the truck, thus being able to start loading smoothly.

Next, a description is given of the operation of the gate management system 1 at the time of the truck loaded with the container exiting from the port after completion of the loading in the port facility.

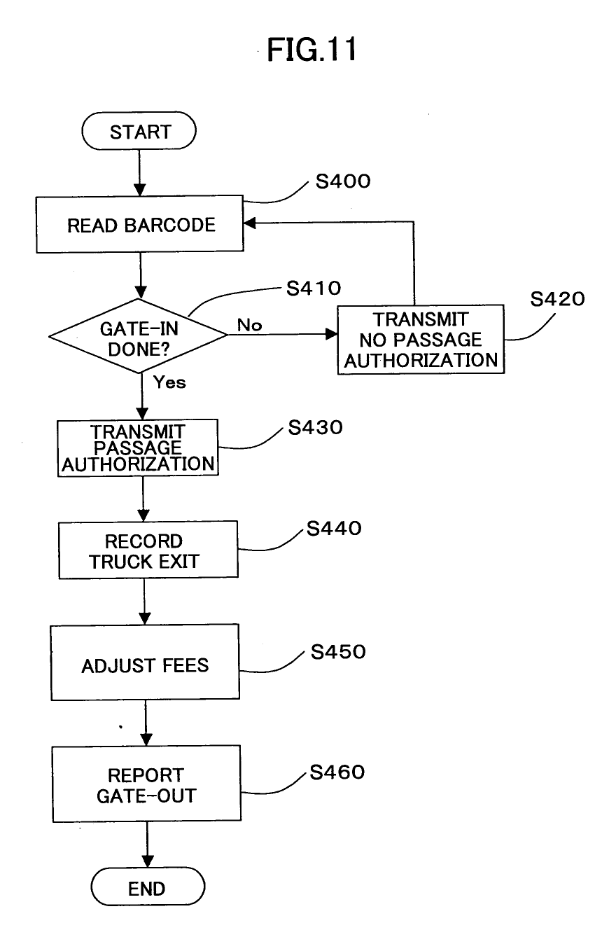

FIG. 11 is a flowchart for illustrating a gate exit operation. In step S400, as in the case of entrance, the barcode reader 30 reads the barcode presented by the trucker cellular phone 80b, and the barcode reader terminal 40 transmits the barcode information to the gate-OUT operation means 120 of the gate management server 10.

In step S410, the gate-OUT operation means 120 retrieves the record corresponding to the container number shown by the barcode information from the container information table 211 of FIG. 5, and determines whether the truck to exit has entered by checking the gate-IN data item of the record. If the entrance of the truck is not recorded in the gate-IN data item (NO in S410), proceeding to step S420 after step S410, the gate-OUT operation means 120 transmits a message that passage is not authorized to the barcode reader terminal 40. At this time, the barcode reader terminal 40 causes the passage authorization lamp 90 to light up in red. If the entrance of the truck is recorded (YES in S410), step S430 is entered.

In step S430, the gate-OUT operation means 120 transmits a message that passage is authorized to the barcode reader terminal 40. At this time, the barcode reader terminal 40 causes the passage authorization lamp 90 to light up in blue, and opens the crossing gate 95 to allow the truck to pass.

Proceeding to step S440 after step S430, the gate-OUT operation means 120 records the exit of the truck in the gate-OUT data item of the container information table 211 of FIG. 5. In step S450, the adjustment means 160 adjusts fees such as fees for container usage, referring to information in the port DB 210, such as the container information table 211.

In step S460, the container information management means 130 obtains a cargo owner address from the container information table 211 of FIG. 5, and the notification means 150 notifies the cargo owner cellular phone 80a of the exit of the truck from the gate and the fees based on the obtained cargo owner address, and the operation ends. Thus, at the time of exit, the trucker can also pass the gate smoothly by only presenting the barcode displayed on the trucker cellular phone 80b to the barcode reader 30. Further, no manpower is required to read the barcode. Therefore, it is possible to have the gate unmanned.

Further, the present invention is also applicable to a toll road. In this case, the gate device 2 composed of the barcode reader 30 and the barcode reader terminal 40 may be installed at tollgates. It is possible to record the point of entrance to the toll road by the barcode reader 30 reading a barcode displayed on a driver's cellular phone or a car navigation device at a tollgate, and to charge at the time of exit from the toll road by also reading the barcode displayed on the driver's cellular phone, etc. This makes it possible to make vehicular traffic smoother at the tollgates of toll roads.

A detailed description is given above of a preferred embodiment of the present invention. However, the present invention is not limited to the specific embodiment, and variations and modifications may be made within the scope of the gist of the present invention recited in CLAIMS. For instance, the application of the present invention to a parking lot makes it possible to report an available parking space to a driver's cellular phone, etc., by reading a barcode displayed on the driver's cellular phone or a car navigation device at the gate of the parking lot, and to charge at the time of exit from the parking lot by also reading the barcode displayed on the driver's cellular phone, etc. Further, the port facilities are taken as an example in the above-described embodiment. On the other hand, in the case of air transportation, it is also possible to apply the present invention in airport facilities in entirely the same manner.

Thus, according to the present invention, a vehicle can pass through a gate by only presenting a gate device with a barcode displayed on a mobile terminal mounted in the vehicle, such as a car navigation device or an automobile telephone, or a portable terminal such as the cellular phone of the crew of the vehicle. Accordingly, procedure time at the gate can be shortened, thus allowing smooth passage of vehicles through the gate.

The present invention is not limited to the above-described embodiment, and variations and modifications may be made within the scope of the present invention.

1. A gate management method in a gate management system having a gate device installed at a vehicle entrance to a predetermined area and a gate management server managing entrance and exit of a passing vehicle, characterized by comprising:
an identification code reading step of reading identification code information displayed on a terminal moving with the vehicle when the vehicle passes the gate device; and
a passage authorization determination step of determining whether to authorize the vehicle to pass based on the read identification code information.

2. The gate management method as claimed in claim 1, characterized by further comprising:
a destination determination step of determining a destination of the vehicle in the predetermined area based on the read identification code information at a time of the entrance of the vehicle; and
a destination notification step of notifying the terminal of the destination of the vehicle determined in the destination determination step.

3. The gate management method as claimed in claim 1, characterized by further comprising a gate passage notification step of notifying a first communications terminal related to the destination of the vehicle that the vehicle has passed the gate device when the passage is authorized in the passage authorization determination.

4. The gate management method as claimed in claim 1, characterized by further comprising an exit notification step of notifying a predetermined second communications terminal that the vehicle has exited based on the identification code information at a time of the exit of the vehicle.

5. The gate management method as claimed in claim 1, characterized in that the identification code is a barcode, and the identification code reading means is a barcode reader.

6. The gate management method as claimed in claim 1, characterized in that the predetermined area is a port facility, and characterized by further comprising a step of assigning the identification code uniquely to each pick-up order and a step of providing the identification code from the gate management server to the terminal.

7. The gate management method as claimed in claim 1, characterized by further comprising a charge amount determination step of determining an amount to be charged for use of the predetermined area based on the identification information read when the vehicle passes the gate.

8. A gate management system having a gate device installed at a vehicle entrance to a predetermined area and a gate management server managing entrance and exit of a passing vehicle, characterized by comprising:
identification code reading means for reading identification code information displayed on a terminal moving with the vehicle when the vehicle passes the gate device; and
passage authorization determination means for determining whether to authorize the vehicle to pass through a gate based on the identification code information read by the identification code reading means.

9. The gate management system as claimed in claim 8, characterized by further comprising:
destination determination means for determining a destination of the vehicle in the predetermined area based on the identification code information at a time of the entrance of the vehicle; and
destination notification means for notifying the terminal moving with the vehicle of the destination of the vehicle determined by the destination determination means.

10. The gate management system as claimed in claim 8, characterized by further comprising gate passage notification means for notifying a first communications terminal related to the destination of the vehicle that the vehicle has passed the gate device based on a result of the determination by the passage authorization determination means.

11. The gate management system as claimed in claim 8, characterized by further comprising exit notification means for notifying a predetermined second communications terminal that the vehicle has exited based on the identification code information at a time of the exit of the vehicle.

12. The gate management system as claimed in claim 8, characterized in that the identification code is a barcode, and the identification code reading means is a barcode reader.

13. The gate management system as claimed in claim 8, characterized in that the predetermined area is a port facility, and the gate management server in advance provides the identification code information assigned uniquely to each pick-up order to the terminal.

14. The gate management system as claimed in claim 8, characterized by further comprising charge amount determination means for determining an amount to be charged for use of the predetermined area based on the identification code information read at the time of the vehicle passage.

15. A gate device installed at a vehicle entrance to a predetermined area, the gate device, together with a gate management server managing entrance and exit of a passing vehicle, forming a gate management system, characterized by comprising:
identification code reading means for reading identification code information displayed on a terminal moving with the vehicle when the vehicle passes the gate device;
identification code information transmission means for transmitting the read identification code information to the gate management server; and
passage authorization output means for receiving passage authorization information from the gate management server and outputting the passage authorization information.

16. A gate management server connected to a gate device installed at a vehicle entrance to a predetermined area, the gate management server managing entrance and exit of a vehicle passing the gate device, characterized by comprising:
identification code information reception means for receiving identification code information read from a terminal moving with the vehicle by the gate device when the vehicle passes the gate device;
passage authorization determination means for determining whether to authorize the vehicle to pass based on the received identification code information; and
passage authorization information transmission means for transmitting passage authorization information showing a result of the determination of the passage authorization determination means to the gate device.

17. A gate management program to be installed in a gate management server connected via a network to a gate device installed at a vehicle entrance to a predetermined area, the gate management server managing entrance and exit of a vehicle passing the gate device, characterized by causing the gate management server to execute:
an identification code information reception process of receiving identification code information read from a terminal moving with the vehicle by the gate device when the vehicle passes the gate device;
a passage authorization determination process of determining whether to authorize the vehicle to pass based on the received identification code information; and
a passage authorization information transmission process of transmitting passage authorization information showing a result of the determination of the passage authorization determination process to the gate device.

18. A recording medium storing a program used in a gate management server connected via a network to a gate device installed at a vehicle entrance to a predetermined area, the gate management server managing entrance and exit of a vehicle passing the gate device, characterized by storing a gate management program including:
a process of causing the gate management server to receive identification code information read from a terminal moving with the vehicle by the gate device when the vehicle passes the gate device;
a process of causing the gate management server to determine whether to authorize the vehicle to pass based on the received identification code information; and
a process of causing the gate management server to transmit passage authorization information showing a result of the determination of the passage authorization determination process to the gate device.
